(19) United States
(12) Patent Application Publication
(10) Pub. No.: US 2008/0306720 A1
(43) Pub. Date: Dec. 11, 2008

(54) Hrtf Individualization by Finite Element Modeling Coupled with a Corrective Model

(75) Inventors: Rozenn Nicol, La Roche Derrien (FR); Sylvain Busson, Rennes (FR); Vincent Lemaire, Trebeurden (FR)

Correspondence Address: MCKENNA LONG & ALDRIDGE LLP, 1900 K STREET, NW, WASHINGTON, DC, 20006, US

(73) Assignee: France Telecom, Paris (FR)

(21) Appl. No.: 12/084,249

(22) PCT Filed: Oct. 18, 2006
(86) PCT No.: PCT/FR2006/002345

§ 371 Date: Jul. 18, 2008

(30) Foreign Application Priority Data
Oct. 27, 2005 (FR) 0510995

(51) Int. Cl. G06F 17/00

(52) U.S. Cl. 703/13

(57) ABSTRACT

The invention relates to modelling individual head related transfer functions (HRTFs) with respect to an individual audition in a three-dimensional space. The inventive method consists in picking up morphological parameters of several individuals for roughly estimating the HRTFs by finite elements and building the database thereof roughly estimated by comparing/training on said database and on another database containing several HRTFs measured in all directions of space and in building, for the same individuals, a model based on an artificial neurone network which is capable to calculate the HRTFs for all directions of space from a series of measurements of morphological parameters of any individuals.

The present invention relates to the modeling of individual transfer functions called HRTFs (Head-Related Transfer Functions), relating to the hearing of an individual in three-dimensional space.

The invention is particularly applicable to the context of telecommunication services offering a broadcasting of the spatialized sound (for example, an audioconference between a number of listeners, a cinema trailer broadcast). On telecommunication terminals, mobiles in particular, sound rendition with a stereophonic headset is envisaged. The most effective technique for positioning sound sources in the space is then binaural synthesis.

Binaural synthesis relies on the use of filters, called “binaural filters”, which reproduce the acoustic transfer functions between the sound source and the ears of the listener. These filters simulate the auditory locating indices, indices which enable a listener to locate the sound sources in a real-life listening situation. These filters take into account all the acoustic phenomena (notably diffraction by the head, reflections on the auricle and the top of the torso) which modify the acoustic wave in its path between the source and the ears of the listener. These phenomena vary strongly with the position of the sound source (mainly with its direction) and these variations enable the listener to locate the source in the space. In practice, these variations determine a sort of acoustic encoding of the position of the source. The auditory system of an individual knows, by learning, how to interpret this encoding to locate the sound sources. Nevertheless, the acoustic diffraction/reverberation phenomena depend just as strongly on the morphology of the individual. A quality binaural synthesis therefore relies on binaural filters which best reproduce the acoustic encoding that the body of the listener naturally produces, by taking into account the individual specifics of its morphology. When these conditions are not satisfied, a degradation of the efficiency of the binaural rendition is observed, which is reflected notably in an intracranial perception of the sources and front/rear confusions. The sources located in front are perceived to be behind and vice-versa.

Among the 3D sound or sound spatialization technologies, in processing the audio signal applied notably to the simulation of acoustic and psycho-acoustic phenomena, some aim to generate signals to be broadcast on loudspeakers or on headphones, in order to give the listener the auditory illusion of sound sources placed in particular respective positions around the listener. This introduces the concept of the creation of virtual sound sources and images.

The binaural techniques described hereinabove are applied to the processing of a 3D sound intended for broadcasting on a headset with two, left and right, earpieces. These techniques aim to reconstruct the sound field at the level of the ears of a listener, such that his eardrums perceive a sound field that is practically identical to that which the actual sources in the 3D space would have induced. The binaural techniques are therefore based on a pair of binaural signals which respectively feed the two earpieces of the headset. These binaural signals can be obtained in two ways:
by direct sound pick-up, using two microphones inserted at the entry of the auditory channel of an individual or of a model with standard morphology (“artificial head”), or
by processing the signal, by filtering a monophonic signal through two binaural filters, these filters reproducing the properties of the acoustic propagation between the source placed in a given position and the two ears of a listener.

The binaural techniques that use binaural filters define the field of the binaural synthesis in an advantageous context of the present invention. Binaural synthesis relies on the binaural filters which model the propagation of the acoustic wave between the source and the two ears of the listener. These filters represent acoustic transfer functions called HRTFS, which model the transformations generated by the torso, the head and the auricle of the listener on the signal originating from a sound source. Each sound source position has an associated pair of HRTFs (one HRTF for the right ear, one HRTF for the left ear). In addition, the HRTFs carry the acoustic imprint of the morphology of the individual on whom they have been measured.

The HRTFs therefore depend not only on the direction of the sound, but also on the individual. They are thus a function of the frequency f, of the position (θ,φ) of the sound source (where the angle θ represents the azimuth and the angle φ represents the elevation), of the ear (left or right) and of the individual.

Conventionally, the HRTFs are obtained by measurement. A selection of directions more or less finely covering all of the space surrounding the listener is initially fixed. For each direction, the left and right HRTFs are measured using microphones inserted at the entry of the auditory canal of a subject. The measurement must be performed in an anechoic room (or “dead room”). Ultimately, if M directions are measured, a database of 2M acoustic transfer functions representing each position of the space for each ear is obtained for a given subject.

In the advantageous context of binaural synthesis, the spatialization effect relies on the use of HRTFs which, for optimum performance, must take into account the acoustic propagation phenomena between the source and the ears, but also the individual specifics of the morphology of the listener. Experimental measurement of the HRTFs directly on an individual is, at the present time, the most reliable solution for obtaining quality and truly individualized binaural filters (taking into account the individual specifics of the morphology of the individual). It will be recalled that the aim is to measure the transfer function between a source located in a given position (θ1, φ1) and the two ears of the subject by means of microphones placed at the entry of the auditory canals of this person.

However, measuring these transfer functions HRTFs presents some difficulties. It requires specific and costly equipment (typically an anechoic room, a microphone, a mechanical device for positioning sources). This operation is lengthy because it is necessary in particular to measure the transfer functions for a large number of directions in order to uniformly cover all of a 3D sphere surrounding the listener.

This measurement of the HRTFs becomes very difficult, even impossible, in the context of binaural synthesis applications intended for the consumer market. HRTF measurement in fact poses at least three main problems:
The measurement of the HRTFs is in itself difficult to implement, because it requires dedicated equipment. The measurement must be performed in an anechoic room. It also requires a mechanical device to move and drive the measuring loudspeaker in order to perform measurements for a large number of directions uniformly distributed in azimuth and in elevation around the listener. Also, the measurement procedure overall is uncomfortable for the subject, because of the constraints imposed on the subject by the measurement system and because of the duration of the measurement.
A second problem lies in the need to measure the HRTFs in a large number of directions to offer a sufficient and uniform spatial sampling of the 3D sphere surrounding the listener. The greater the number of measured directions, the longer the measurement takes, which increases the discomfort of the subject.
A third problem concerns the measurement of a particular individual. Offering an efficient binaural synthesis to any individual presupposes using his own HRTFs, which will need to have been measured first, which is normally not possible.

Solutions that require a minimum of HRTF measurements and implement more modeling techniques have therefore been researched. In particular, mathematical models of HRTFs have been studied that consist of a function F enabling an HRTF (Y) to be expressed based on a set of parameters (X) given a priori, such as Y=F(X). Often, two key elements are involved:
the finalization of the mathematical model (function F), and
the specification of the set of parameters to be applied as input to the model.

There now follows a description of the state of the art as known to the inventors concerning the HRTF modelings implemented to date, focusing attention on the choice of the model input parameters.

The document US-2003/138107 describes a statistical model of HRTFs based on morphological data. This approach starts from a statistical analysis applied to a database including HRTFs and morphological data. An analysis by main components is first applied on the one hand to the HRTFs and on the other hand to the morphological data, which makes it possible to describe all of the data with a restricted number of components. Then, a linear regression is performed between the components obtained from the analysis by main components of the HRTFs and the components obtained from that of the morphological data. A statistical model is thus established which links the morphological data to the HRTFs. All that is then needed is to measure the morphological parameters of any individual to predict his HRTFs based on the statistical model obtained.

However, this document also provides for the morphological data of an individual to be enriched at the model input with a few HRTFs measured on this individual and in specific respective directions.

Thus, even if the number of measurements is limited in this document, it is still necessary to observe the HRTF measurement protocol, in particular to provide an anechoic room for the measurements and strictly position the sources at very precise distances from the microphones which are attached to the ears of the individual.

The implementation of the present invention overcomes such constraints.

To this end, the present invention aims for a method of modeling transfer functions HRTFs specific to an individual, in which there are provided:
an initial model construction step in which:
   a) a first database is constructed, including a plurality of HRTFs measured in a multiplicity of directions of the space and for a plurality of individuals,
   b) a second database is constructed, including specific and respective morphological parameters of said plurality of individuals,
   c) from said morphological parameters of the second database, a finite element modeling is applied to obtain a third database including specific and respective modeled HRTFs of said plurality of individuals, for at least some of said multiplicity of directions,
   d) by comparison and learning on the data from the first and third databases, a corrective model is constructed that is suitable for giving HRTFs that are modeled and adjusted for said multiplicity of directions,
and a current step for determining the HRTFs in said multiplicity of directions, for any individual, in which:
   e) morphological parameters of the any individual are measured, and
   f) modeled and corrected HRTFs of the any individual are obtained by applying the finite element modeling and said corrective model to the morphological parameters of the any individual.

Thus, the present invention intends to exploit the advantages of the technique described in the document FR-2 851 877, whereby it is possible to model, at least roughly, the HRTFs of an individual for whom an appropriate set of morphological parameters have been measured. It typically involves a finite element modeling, which amounts to estimating, according to their direction of origin, the disturbances that the acoustic waves undergo when they encounter an obstacle corresponding to the bust of the individual. In particular in this document FR-2 851 877, it is proposed to measure general dimensions of the head and of the torso of an individual, and to model at least the head and the torso of the individual by simple geometrical shapes (for example, ellipsoids for the head and the torso and a cylinder for the neck), the dimensions of these simple shapes corresponding to the dimensions measured on the individual. The finite element modeling is then applied to these simple shapes. Modeled HRTF results are obtained which are satisfactory in the sense that the HRTFs obtained can at least be differentiated from one individual to another, in particular in the low and medium acoustic frequencies. For the higher frequencies, this document FR-2 851 877 proposes also to identify at least the position of an ear on the head of the individual and preferably the shape of the auricle of the ear as well. However, the quality of the duly modeled HRTFs still had to be perfected and the present invention to this end proposes applying a corrective model, advantageously implementing an artificial neural network, in particular in the model construction step d) of the above method.

When a comparison and learning phase is implemented to construct the model, particularly if an artificial neural network is used, it is preferable for the morphological parameter measurement conditions to be roughly reproducible at least between the model construction step and the current step conducted on any individual. It is also preferable for the simplified geometrical model, and the finite element computation model, to be reproducible.

To this end, the procedure for measuring morphological parameters which is described in FR-2 851 877 can be taken up again here. Typically, an installation can be provided for estimating transfer functions HRTFs specific to an individual, comprising:
a booth for measuring morphological parameters of an individual, and
a processing unit capable of evaluating the HRTFs of the individual in a multiplicity of directions of the space by applying to the morphological parameters of the individual a finite element modeling and a corrective model based on learning, and advantageously implementing an artificial neural network.

The present invention also aims for such an installation.

Advantageously, the installation can be equipped with means of photographing, from at least two different angles (for example front and profile), at least the bust of an individual to deduce therefrom general dimensions of his head, his torso, or other parts. To this end, the booth can include, in a preferred embodiment, a measurement standard such that the photographs show, with the bust of the individual, the measurement standard. Shape recognition means, for example, can then be used to measure the morphological parameters that are involved in the modeling.

Thus, this installation makes it possible to implement at least the current step of the method in the sense of the invention.

It is then sufficient, in the current step, to supply:
a set of morphological parameters of any individual, measured for example with the installation described hereinabove, and
at least one chosen direction from a multiplicity of directions in the space and in which an estimation of HRTFs is desired,
   and modeled and adjusted HRTFs are obtained for this chosen direction.

In a general embodiment, provision can be made to model by finite elements the HRTFs in all the multiplicity of directions of the space, then to refine the model by comparison/learning between all these modeled HRTFs and all the measured HRTFs of the first base.

As a variant, it is possible to proceed as follows.

It has been possible to prove that the modeling of the HRTFS by finite elements is more effective in certain particular directions, in as much as, for these directions, the HRTFs modeled by finite elements are closer to the measured HRTFS than for the other directions, and this regardless of the individual. Thus, on completion of the finite element modeling, it is possible ultimately to retain only these best modeled HRTFs that correspond to preferred directions and carry out the comparison only on these preferred directions.

On the other hand, the learning will be conducted over all the multiplicity of directions of the space.

Thus, in more generic terms, to apply the model construction step, based on said morphological parameters of the second database and by comparison with the measured HRTFS of the first database, preferred directions of the space are selected according to which the finite element modeling supplies modeled HRTFs close to the measured HRTFs in these preferred directions, and
in the step c), based on said morphological parameters of the second database, a finite element modeling is applied to obtain a third database containing specific and respective modeled HRTFs of said plurality of individuals, according to said preferred directions,
in the step d), by comparison and learning on the data of the first and third databases, a corrective model is constructed suitable for giving modeled and adjusted HRTFs for the multiplicity of directions.

As a complement or a variant, it is possible to assume that all the directions are not equivalent in terms of individualization and there are preferred directions which are more “individual” than the others, in as much as the HRTFs in these directions carry a greater wealth of individual information than the others. For example, the directions where the contribution of the auricle is more marked, or even predominant, are potentially strongly individual directions. It then seems relevant to focus the finite element modeling on these directions, which can then give another criterion, for example complementary, for the selection of preferred directions of the modeled HRTFs.

The present invention also aims for a computer program product, designed to be stored in a memory of a processing unit or on a removable medium designed to cooperate with a drive of said processing unit, or intended to be transmitted from a server to said processing unit. The program comprises instructions in computer code form to construct a model based on learning and advantageously implementing an artificial neural network, capable of giving transfer functions HRTFs of an individual for a multiplicity of directions, based on a set of measurements, performed on this individual, of morphological parameters of this individual. The program then creates, from a first database including a plurality of HRTFs according to a multiplicity of directions of the space and for a plurality of individuals, and a second database including morphological parameters of these individuals, at least one finite element modeling, followed by a comparison/learning phase.

The present invention also aims for a second computer program product, designed to be stored in a memory of a processing unit or on a removable medium designed to cooperate with a drive of said processing unit, or intended to be transmitted from a server to said processing unit. The program comprises instructions in computer code form to create a model based on learning and advantageously implementing an artificial neural network, this model being capable of giving transfer functions HRTFs of an individual for a multiplicity of directions, based on a set of measurements performed on this any individual, of morphological parameters of this any individual.

Thus, the first program described hereinabove can be used to construct the model, whereas the second program consists of computer instructions representing the model itself.

Other characteristics and advantages of the invention will become apparent from studying the detailed description hereinbelow, and the appended drawings in which:

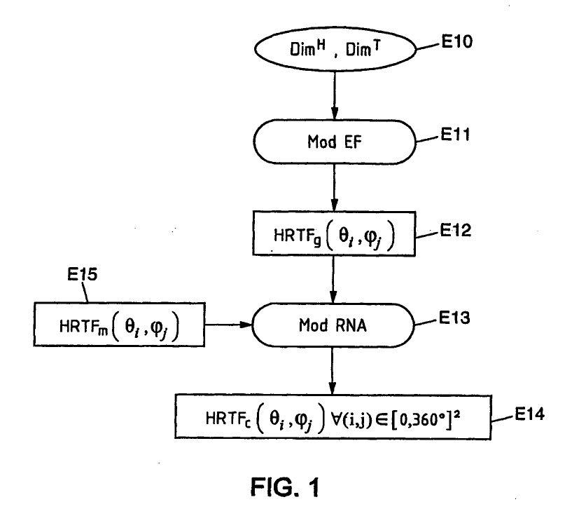

FIG. 1 diagrammatically illustrates the main steps of the method according to the invention,

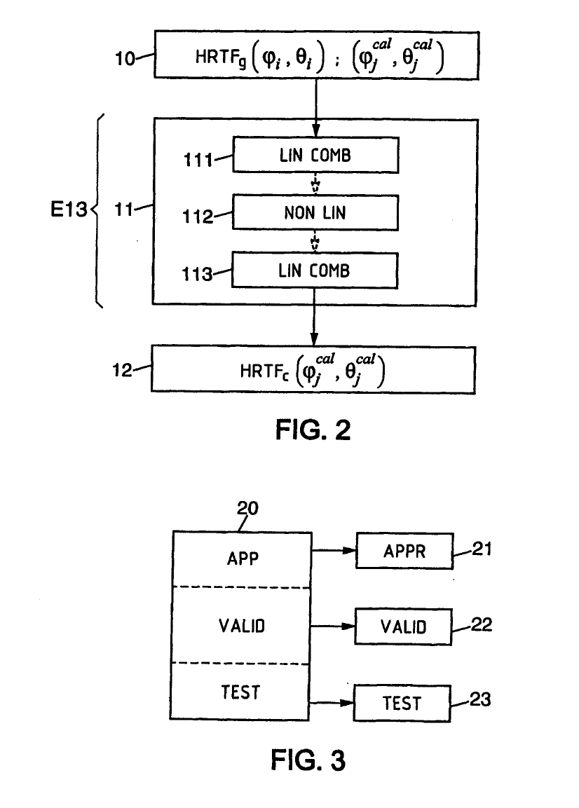

FIG. 2 diagrammatically illustrates the operating steps of a model implementing an artificial neural network, able then to correspond to a flow diagram diagrammatically representing the progress of the second computer program described hereinabove,

FIG. 3 diagrammatically illustrates the model construction steps, possibly corresponding to a flow diagram diagrammatically representing the progress of the first computer program described hereinabove,

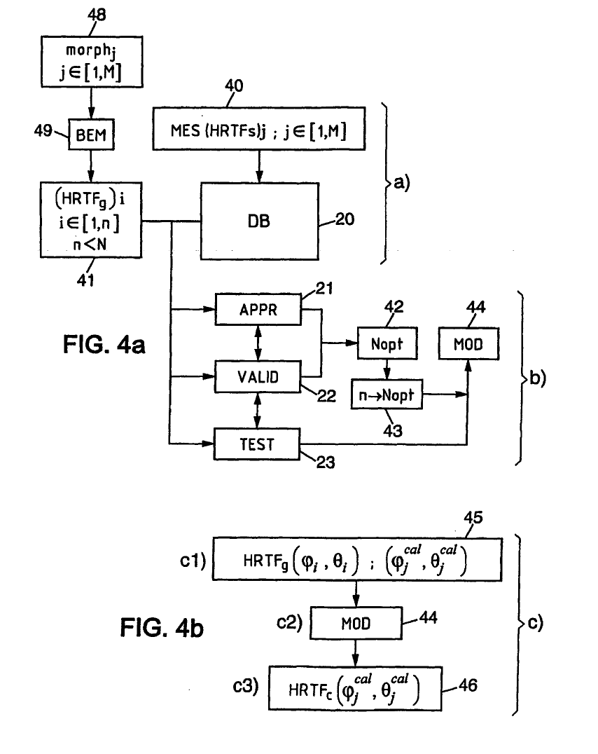

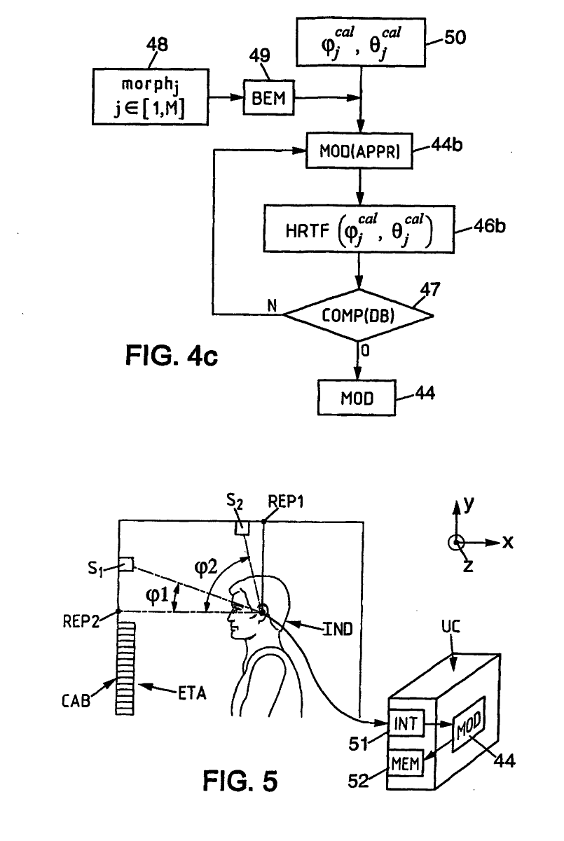

FIG. 4a diagrammatically illustrates the first model construction step in a method according to the invention,

FIG. 4b diagrammatically illustrates the current step using the model constructed in a method according to the invention,

FIG. 4c diagrammatically illustrates an advantageous embodiment for the construction of the abovementioned model, and

FIG. 5 diagrammatically represents an installation for implementing the invention.

There now follows, first of all, a review of the principle of the construction of a model using a comparison/learning phase.

It involves in particular calculating the transfer functions HRTFs by means of a mathematical model based on a function F which makes it possible to express a transfer function on the basis of a number of input parameters. More specifically, if the desired transfer function is represented in the form of a vector Y (Y ε [symbol] , n ε [symbol] ) and if the input parameters are described in the form of a vector X (X ε [symbol] , m ε [symbol] ), the function F defines the following relation: Y=F(X). In other words, the function F can be used to deduce a transfer function of a given set of a priori known parameters. The benefit of the mathematical model lies in the use of input parameters which can easily be acquired for any individual, while keeping in mind, however, that their relation with the transfer function is not necessarily direct or obvious. The mathematical model must, in particular, be capable of extracting the information that is more or less hidden in the input parameters in order to deduce therefrom the desired transfer function. The inventive method relies mainly on two points:
the definition of the function F,
the determination of the input parameters X.

The mathematical model of the HRTFs relies on a function F making it possible to express an HRTF on the basis of a given number of input parameters. The input parameters are grouped together in a vector X (X ε [symbol] , m ε [symbol] ) which therefore constitutes the input vector of the function F. The output vector of the function is an HRTF which is represented by a vector Y (Y ε [symbol] , n ε [symbol] ). For example, this vector Y can comprise frequency coefficients describing the modulus of the spectrum of the transfer function defined by the HRTF. In an equivalent way, Y can comprise:
time coefficients describing the impulse response associated with the transfer function defined by the HRTF, or
frequency coefficients describing the complex spectrum of the transfer function defined by the HRTF.

The function F is therefore a function of [symbol] in [symbol] .

The modeling problem involves determining the function F, in association with a relevant set of parameters (X), such that any HRTF (Y) is the solution of: Y=F(X).

Specifically to estimate the HRTFs of an individual, the input vector X of the model mainly contains information relating to:
the direction in which an HRTF is to be calculated, preferably in the form of an azimuth angle (θ) and an elevation angle (φ),
and “individual” parameters (such as HRTFs estimated from morphological parameters of the individual and by a finite element modeling in all or only some directions of the space, as will be seen hereinbelow), these individual parameters (therefore indirectly corresponding to the morphological parameters) being intended to add to the model information relating to the specifics of the individual for whom the HRTFs are to be calculated.

The output vector Y of the model consists of coefficients associated with a given representation of an HRTF. As indicated hereinabove, the vector Y can correspond to the frequency coefficients describing the modulus of the spectrum of an HRTF, but other representations can be considered (analysis by main components, IIR filter, or other).

As represented in FIG. 1, the model is applied here for the purposes of correction and, optionally, interpolation. Morphological parameters such as the dimensions of the head Dim^{H} and/or of the torso Dim^{T} of an individual are measured on this individual (step E10). Finite element modeling is then used (step E11) to deduce therefrom the estimated HRTFs HRTF_{g}(θᵢ, ⱼ) for all or some of the directions of the space (step E12). The corrective model based on an artificial neural network is then used (step E13) to calculate the corrected HRTFs HRTF_{c}(θᵢ, ⱼ) of this individual in all the directions (over 360°) covering all of the 3D sphere (step E14), and this by comparison with a first database of actual measurements of the HRTFs of this same individual (denoted HRTFₘ(θᵢ, ⱼ)) in all the 3D sphere (step E15 of FIG. 1). The previously estimated HRTFs are therefore used as input parameters for the corrective model of step E13, and the HRTFs measured previously E15 are used as input comparison parameters also for the corrective model of the step E13.

Generally, modeling based on an artificial neural network consists mainly in:
determining the function F which best approaches the relationship between X and Y,
determining the set X of input parameters that are best suited, in relation to the function F, notably in terms of quality and quantity of the information added by the parameters and which can be exploited by the model used.

The determination of F and of the vector X are quite obviously not independent.

There is a wide variety of mathematical methods for determining these two entities F and X. The inventive method is preferably based on statistical learning algorithms and, in a preferred embodiment, on algorithms of the artificial neural network type. These algorithms are briefly described hereinafter.

The statistical learning algorithms are statistical process prediction tools. They have been successfully used to predict processes for which a number of explanatory variables can be identified. The artificial neural networks define a particular category of these algorithms. The benefit of the neural networks lies in their capacity to pick up high-level dependencies, that is, dependencies that involve a number of variables at a time. Process prediction exploits the knowledge and use of high-level dependencies. There is a wide variety of applicable domains for neural networks, notably in financial techniques to predict market fluctuations, in pharmaceuticals, in the banking sector to detect credit card fraud, in marketing to forecast consumer behavior, and other sectors. Neural networks are often considered as universal predictors, in the sense that they are capable of predicting any data from any explanatory variables, provided that there are enough hidden units. In other words, they can be used to model any mathematical function of [symbol] in [symbol] , provided that the number of hidden units is sufficient.

Referring to FIG. 2, a neural network consists of three layers: an input layer 10, a hidden layer 11 and an output layer 12. The input layer 11 corresponds to the explanatory variables, that is, the input variables (the abovementioned vector X), from which the prediction is made, and which will be described in detail below. The output layer 12 defines the predicted values (the abovementioned vector Y).

In the hidden layer, a first step 111 consists in calculating linear combinations of the explanatory variables so as to combine the information potentially originating from several variables. A second step 112 can consist in applying a nonlinear transformation (for example, a function of the “hyperbolic tangent” type) to each of the linear combinations in order to obtain the values of the hidden units or neurons that form the hidden layer. This nonlinear transformation defines the activation function of the neurons. Finally, the hidden units are linearly recombined, in the step 113, in order to calculate the value predicted by the neural network.

Initially, finalizing a neural network involves three operations:
learning, consisting in optimizing, for a given architecture of the neural network, the parameters of the network from a series of training examples (forming the learning set), from which the neural network tries to minimize its prediction error;
the validation procedure, conducted in parallel with the learning and intended to optimize the architecture of the network, in order for the neural network not to overlearn the learning set. The network models only the fundamental dependency relationships and does not try to reproduce the relationships that are due only to statistical fluctuations of the learning set. In addition to the learning error, a prediction error is thus evaluated on examples obtained from a validation set, which is separate from the learning set. This error defines the validation error. For example, it begins by decreasing when the number of hidden layers is increased, reaches a maximum, then increases when the number of hidden layers becomes too great. The minimum therefore defines an optimal number of hidden layers of the network;
calculation of the final prediction error, on a third test set, separate from the previous two sets.

There are various categories of neural network that are distinguished by their architecture (type of interconnection between neurons, choice of activation functions, or other factors) and the learning mode used.

The neural networks are not only used for prediction purposes. They are also used for classifying and/or clustering data with a view to reducing the information. In practice, a neural network can, in a data set, identify common characteristics between the elements of that set, to then combine them according to their resemblance. Each duly constructed cluster then has associated with it an element representative of the information contained in the cluster, called “representative”. This representative can then replace the whole of the cluster. The data set can thus be described by means of a small number of elements, which represents a data reduction. Kohonen maps or self-organizing maps (SOM) can be neural networks dedicated to this clustering task.

A question arises concerning the act of choosing all the HRTFs, roughly estimated by the finite element modeling, as input for the model with artificial neural network 11 or if only a few HRTFs estimated in preferred directions could be used, as indicated hereinabove.

It will also be recalled that the roughly estimated HRTFs can be determined from a finite element modeling by considering, for example, simple geometrical shapes for the head, the torso, the neck, or other parts of an individual, as described in document FR-2 851 877, without going into this description in detail here.

The method that seemed to be the most immediate consisted in a uniform selection from which a subset of roughly estimated HRTF directions was chosen, seeking to cover all of the 3D sphere as uniformly and evenly as possible. This method relied on a regular sampling of the 3D sphere. Now, it turned out that the HRTFs did not vary uniformly according to direction. From this point of view, a uniform selection of the HRTFs was not really optimal.

A more promising method involved applying the abovementioned clustering technique in order to identify the directions of the most “relevant” HRTFs, that is, those most representative of the characteristics of the HRTFs observed over all of the 3D sphere. When it is applied in determining the HRTFs of an individual, this clustering technique can involve:
in a first step, identifying the redundancies between the HRTFs of adjacent directions,
in a second step, clustering the HRTFs according to a resemblance criterion,
in a third step, the whole of the 3D sphere surrounding the listener is thus subdivided into a small number of zones which correspond to the various HRTF clusters identified previously, and
in a fourth step, each cluster has associated with it an HRTF which is considered to be the representative of the group.

This “representative” HRTF is one of the HRTFs of the cluster and it is selected as the HRTF which minimizes a distance criterion with all the other HRTFs of the cluster. The representative HRTF contains most of the information from the HRTFS of the cluster. Ultimately, the set of the duly obtained representative HRTFs constitutes a compact description of the properties of the HRTFs for all of the 3D sphere.

This technique had given good results with regard to the model. The first result is a data reduction. The clustering procedure adds supplementary information as to the directions associated with the representative HRTFS, this information making it possible to define a selection of HRTFs intended to feed the input of the HRTF calculation model. This selection is a priori non-uniform, but more effective, and guarantees a better “representativeness” of the whole of the 3D sphere.

Nevertheless, it became apparent to the inventors that the greatest selectivity providing effective “clustering” was observed between distinct morphotypes of individuals, rather than between distinct directions of HRTFs. The inventors then favored the exhaustiveness of the database of morphological parameters, in particular by choosing a wide variety of morphotypes. It was then preferred to deduce from this base a new base containing the HRTFs modeled by finite elements for all these individuals and in all the directions of the space. It is these HRTFs that are then supplied as input to the corrective model illustrated by the step 11 of FIG. 2.

Preferably, the invention uses statistical learning algorithms of the “artificial neural network” type, as modeling tool for the corrective calculation of the HRTFs (for example, with a neural network of “Multi-Layer Perceptron” (MLP) type). The input parameters of the neural network are at least the azimuth angle (θ1) and elevation angle (φ1) specifying the direction of an HRTF to be calculated, and the HRTFs roughly estimated by means of the finite element model.

The output parameters of the model are then the coefficients of the vector describing the HRTF for the direction (θ1, φ1) and for the individual for whom the HRTFs had been estimated by the finite element modeling.

Referring again to FIG. 2, the principle of the calculation of the HRTFs by the implementing of an artificial neural network (for example of MLP type) consists:
of the input layer 10 comprising input parameters then including:
   the roughly estimated HRTFs denoted HRTF_{g}(ᵢ, θᵢ), with i between 1 and n,
   the directions for which the HRTFs are to be calculated, preferably specified in the form of an elevation angle φⱼ^{cal}) and an azimuth angle (θⱼ^{cal}), with j between 1 and N, N possibly being different from and in particular greater than n,
the output layer 12 giving the corrected HRTFs of the individual in the directions (φⱼ^{cal}, θⱼ^{cal}) specified as input, and
one or more hidden layers 11 which will seek, by adjusting the weights and the activation functions of the neurons, to best model the relationships between the input layer and the output layer.

To refer now to FIG. 3, implementing a neural network involves three steps:
the learning phase 21,
the validation phase 22, and
the test phase 23.

To successfully complete these three phases, there is initially a database 20 of HRTFs roughly estimated on one or more individuals. Thus, it will be understood that a preliminary step for collecting morphological parameter measurements for a number of individuals and, from there, their roughly estimated HRTFs in all the directions of the space, is applied. This is how the database 20 is constructed.

This database 20 is subdivided into three distinct sets:
a learning set (APPR),
a validation set (VALID),
a test set (TEST).

For the learning phase 21, there are pairs available which combine:
an input vector X (describing the description of the HRTF to be calculated and the individual parameters such as the rough estimation of the HRTFs in all or some directions),
and an output vector Y (corresponding to the HRTF that the neural network should best estimate).

The learning involves, for each duly formed pair obtained from the learning set:
optimizing the neural network (in terms of the weights and the activation functions of the neurons),
and comparing the result obtained by the neural network and the expected result (corresponding to an HRTF actually measured on the individual and stored in the abovementioned first database, as illustrated by the reference E15 of FIG. 1), so as to minimize a given error criterion.

One risk of the learning phase is overlearning which is reflected as follows: the neural network learns “by heart” the learning set and seeks to reproduce variations specific to the learning set, although they do not exist at the global level. To avoid overlearning, the validation phase 22 is conducted together with the learning phase 21. It consists in evaluating the prediction error of the neural network on a validation set (distinct from the learning set), which defines the validation error. During the learning process, the validation error begins by decreasing, then starts to increase again when the overlearning occurs. The minimum of the validation error therefore determines the end of learning.

In practice, this observation directly affects the number of estimated HRTFS to be supplied as input to the model, after the learning phase. It will then be understood that an advantageous optional characteristic provides for determining an optimum number of roughly estimated HRTFs to be supplied as input to the model.

The test phase is conducted once the learning phase is finished and consists in evaluating the prediction error on the test set. This so-called “test error” ultimately describes the final performance of the neural network.

On completion of these three phases, there is an operational neural network available, to which it is enough to submit input parameters to obtain the HRTFS of any individual in any direction.

Thus, with reference to FIG. 4a, the method illustrated by way of example therefore comprises a step a) during which a database 20 is constructed by measuring a plurality of HRTFs in a multiplicity of directions of the space and for a plurality of individuals. This measurement step referenced 40 in FIG. 4a consists in collecting the measurements of HRTFS in N directions of the space, for M individuals preferably of different morphology (or morphotype), to obtain an exhaustive database according to the specifics of the individuals. More generally, the greater the number of individuals taken into account in the learning phase, the better the performance of the neural network, particularly in terms of “universality”.

The next step b) consists of the learning of the model by using this database 20 and another database 41 containing HRTFs roughly estimated from a finite element modeling 49 (or “BEM”) applied to the morphological parameters 48 specific to the same individuals. A small number n (with n<N) of directions i representative of HRTFS are chosen arbitrarily in the step 41. This step 41 will be described in detail later, with reference to FIG. 4c. The three learning 21, validation 22 and test 23 phases are then conducted to construct the model in the step 44. It will be noted that it is possible to adjust the number of roughly estimated HRTFs to avoid the overlearning issue described hereinabove. Thus, it is possible to determine an optimum number Nopt of roughly estimated HRTFs that are necessary to the correct operation of the model (step 42) and adopt this optimum number (step 43) for the definition of the model. Ultimately, the neural network 44 is obtained to calculate the HRTFs. The neural network 44 is then capable of calculating the HRTFs of any individual, in any direction, provided that there are a few morphological parameters of the individual available.

Referring to FIG. 4c, an optional aspect of the invention is now specified for a preferred embodiment of the learning of the model. In practice, the database 20 must be constructed in the most conventional and the most standard conditions to offer, at the output of the model, quality HRTFs which can be applied to playback devices, offering a satisfactory listening comfort.

On the other hand, a second type of measurements 48 is carried out, performed on the same individuals as those on whom the measurements constituting the database 20 of measured HRTFs were conducted, and consisting in recording the morphological parameters of these M individuals (dimensions of the head, torso, neck, position and shape of the ears, etc.). To each set of morphological parameters morphⱼ of an individual j, a finite element modeling 49 is applied to obtain estimated HRTFs in at least some of the directions of the space.

Moreover, during a step 50, the directions (ⱼ^{cal}, θⱼ^{cal}) in which the HRTFs must be calculated are specified as input for the model. Preferably, it will obviously concern the greatest possible number of directions of the 3D space. A version of the model 44b, in the learning state, calculates the corrected HRTFs in these directions (ⱼ^{cal}, θⱼ^{cal}) from the roughly estimated HRTFs, in a following step 46b. The model compares these calculated and corrected HRTFs with the HRTFs in the database 20 in the same directions (ⱼ^{cal}, θⱼ^{cal}). If the difference is deemed to be too great (N arrow), the model in the learning state 44b is refined until this difference is reduced to an acceptable error (◯ arrow): the model then becomes definitive (end step 44).

Referring to FIG. 5, there now follows a description of an exemplary installation for measuring morphological parameters that will be used to determine the modeled and corrected HRTFs. The individual IND is placed in a booth CAB. He positions his bust preferably in relation to a summit fix REP1 and a front fix REP2 provided in the booth CAB. This embodiment makes it possible to keep the individual IND correctly positioned in relation to two photographing means S₁ and S₂ at two distinct angles 1 and 2 and, consequently, to obtain a 3D topography of his bust, with, in particular, the dimensions of the head, the torso, the neck, and so on, of the individual.

Advantageously, the booth includes a measurement standard ETA which will serve as a scale for measuring these dimensions. In particular, the photographing means S₁ and S₂ incorporate, in their field, the measurement standard ETA with the bust of the individual IND.

To refer again to FIG. 5, the photographs can be analyzed by shape recognition means to measure the morphological parameters of the individual. In practice, image signals are collected by an interface 51 of a central processing unit CPU, which converts them into digital data. This data is then processed to determine the morphological parameters 48 and, from that, the rough HRTFs by applying the BEM model (step 49). Finally, these roughly estimated HRTFs are processed by the artificial neural network-based model 44. The model 44 can be stored in the form of a computer program product in a memory of the central processing unit CPU. The HRTFs calculated for all the directions of the space given by the model can then be stored in memory 52 or saved on a removable medium (on diskette or burned onto CD-ROM) or even communicated via a network such as the Internet or equivalent.

It should be indicated, however, that the protocol for measuring the morphological parameters on the one hand and the measured HRTFs in the base 20 on the other hand, should preferably be defined previously and be followed roughly in the same way, for all the individuals. The duly obtained neural network is capable of calculating the HRTFs of any individual, in any direction, provided that there are measurements of his morphological parameters available.

Of course, the present invention is not limited to the embodiment described hereinabove by way of example; it extends to other variants.

For example, instead of providing two photographs to measure the morphological parameters, it will be possible to provide for a 3D laser reading of the bust of an individual.

1. A method of modeling transfer functions HRTFs specific to an individual, wherein there are provided:
an initial model construction step in which:
a) a first database is constructed, including a plurality of HRTFs measured in a multiplicity of directions of the space and for a plurality of individuals,
b) a second database is constructed, including specific and respective morphological parameters of said plurality of individuals,
c) from said morphological parameters of the second database, a finite element modeling is applied to obtain a third database including specific and respective modeled HRTFs of said plurality of individuals, for at least some of said multiplicity of directions,
d) by comparison and learning on the data from the first and third databases, a corrective model is constructed that is suitable for giving HRTFs that are modeled and adjusted for said multiplicity of directions,
and a current step for determining the HRTFs in said multiplicity of directions, for any individual, in which:
e) morphological parameters of the any individual are measured, and
f) modeled and corrected HRTFs of the any individual are obtained by applying the finite element modeling and said corrective model to the morphological parameters of the any individual.

2. The method as claimed in claim 1, wherein:
the morphological parameter measurement conditions are substantially reproducible at least between the model construction step and the current step conducted on any individual.

3. The method as claimed in claim 1, wherein:
at least one of the general dimensions of the head and of the torso of an individual is measured, and
at least the head and the torso of the individual are modeled by simple geometrical shapes of dimensions corresponding to the measured general dimensions, to apply said finite element modeling.

4. The method as claimed in claim 3, wherein at least the position of an ear on the head of the individual is also identified.

5. The method as claimed in claim 3, wherein at least a front and profile photograph of the bust of the individual is obtained to deduce said general dimensions therefrom.

6. The method as claimed in which claim 1, wherein the corrective model of the step d) is constructed by setting up an artificial neural network.

7. The method as claimed in claim 1, wherein, to apply the model construction step, based on said morphological parameters of the second database and by comparison with the measured HRTFs of the first database, preferred directions of the space are selected according to which the finite element modeling supplies modeled HRTFs close to the measured HRTFs in these preferred directions, and
in the step c), based on said morphological parameters of the second database, a finite element modeling is applied to obtain a third database containing specific and respective modeled HRTFs of said plurality of individuals, according to said preferred directions,
in the step d), by comparison and learning on the data of the first and third databases, a corrective model is constructed suitable for giving modeled and adjusted HRTFs for the multiplicity of directions.

8. The method as claimed in claim 1, wherein, in the current step, there are provided:
a set of morphological parameters of any individual, and
at least one chosen direction from said multiplicity of directions in which an estimation of HRTFs is desired,
and modeled and adjusted HRTFs are obtained for this chosen direction.

9. An installation for implementing the method as claimed in claim 1, for estimating transfer functions HRTFs specific to an individual, comprising:
a booth for measuring morphological parameters of an individual, and
a processing unit capable of evaluating the HRTFs of the individual in a multiplicity of directions of the space by applying to the morphological parameters of the individual a finite element modeling and a corrective model based on learning.

10. The installation as claimed in claim 9, wherein the booth includes a measurement standard, the installation also comprising means of photographing the bust of the individual from at least two camera angles, showing, with the bust of the individual, said measurement standard.

11. A computer program product, designed to be stored in a memory of a processing unit or on a removable medium designed to cooperate with a drive of said processing unit, or intended to be transmitted from a server to said processing unit, comprising instructions in computer code form to implement the initial step of the method as claimed in claim 1, to construct a model based on learning and capable of giving transfer functions HRTFs of an individual for a multiplicity of directions, based on a set of measurements, performed on this individual, of morphological parameters of this individual, the program implementing, based on a first database including a plurality of HRTFs according to a multiplicity of directions of the space and for a plurality of individuals, and a second database including morphological parameters of these individuals, at least one finite element modeling, followed by a comparison/learning phase.

12. A computer program product, designed to be stored in a memory of a processing unit or on a removable medium designed to cooperate with a drive of said processing unit, or intended to be transmitted from a server to said processing unit, comprising instructions in computer code form to implement the current step of the method as claimed in claim 1, to apply a model based on learning and capable of giving transfer functions HRTFs of an individual for a multiplicity of directions, based on a set of measurements performed on this any individual, of morphological parameters of this any individual.
